(19) United States
(12) Patent Application Publication
(10) Pub. No.: US 2003/0110649 A1
(43) Pub. Date: Jun. 19, 2003

(54) Automatic calibration method for substrate carrier handling robot and jig for performing the method

(75) Inventors: Jeffrey C. Hudgens, San Francisco, CA (US); Martin R. Elliott, Round Rock, TX (US); Kirk Van Katwyk, Tracy, CA (US)

Correspondence Address: APPLIED MATERIALS, INC., 2881 SCOTT BLVD. M/S 2061, SANTA CLARA, CA, 95050, US

(73) Assignee: APPLIED MATERIALS, INC.

(21) Appl. No.: 10/025,081

(22) Filed: Dec. 19, 2001

(51) Int. Cl. G01C 15/00

(52) U.S. Cl. 33/286

(57) ABSTRACT

A jig used in a substrate carrier handling robot calibration process has features that emulate the overhead transport flange and the bottom surface of a standard substrate carrier. The jig further includes features that are allowed to interact with sensors associated with substrate carrier storage locations and/or sensors associated with an end effector of the substrate carrier handling robot. In calibrating the substrate carrier handling robot the jig is juxtaposed with a substrate carrier storage location. The end effector of the robot is moved relative to the substrate carrier storage location and the above-mentioned sensors are allowed to interact with the jig. A controller for the robot detects locations of the end effector at times when the sensors interact with the jig.

### FIELD OF THE INVENTION

This invention is concerned with semiconductor manufacturing equipment, and is more particularly concerned with installation of such equipment.

### BACKGROUND OF THE INVENTION

Semiconductor devices are made on substrates, such as silicon wafers or glass plates, for use in computers, monitors and the like. These devices are made by a sequence of fabrication steps, such as thin film deposition, oxidation or nitration, etching, polishing, and thermal and lithographic processing. Although multiple steps may be performed in a single processing station, substrates must be transported between processing stations for at least some of the fabrication steps. Substrates are stored in open cassettes or sealed pods (hereinafter collectively referred to as “substrate carriers”) for transfer between processing stations and other locations. Although substrate carriers may be carried manually between processing stations, the transfer of substrate carriers is typically automated. For example, a substrate carrier may be transported to a processing station via an automatic guided vehicle (AGV), and then at the processing station loaded from the AGV onto a loading platform by a robot. Another robot may extract a substrate from the substrate carrier and transport the substrate into a processing chamber at the processing station. When the fabrication steps are complete, the substrate is loaded back into the substrate carrier. Once all the substrates have been processed and returned to the substrate carrier, the substrate carrier is removed from the loading platform and transported to another location by the AGV.

Before or after extraction of substrates from the substrate carrier for processing, the substrate carrier may be stored on a storage shelf that is provided adjacent the processing station, or at a stocker unit that stores substrate carriers for a bay of processing stations.

FIG. 1 is an isometric view of a substrate carrier loading and storage station 20. In practice the loading and storage station may be installed adjacent to an interface to a substrate processing station (not shown). The interface to the substrate processing station may include one or more docking stations 51 on which a substrate carrier is positioned to permit a substrate-handling robot (not shown) associated with the substrate processing station to unload substrates from the substrate carrier and to load the substrates into the substrate processing station. Docking stations may include what is sometimes referred to as an automatic door opener which automatically removes the door portion of a sealed substrate carrier.

An exemplary loading and storage station of the type illustrated in FIG. 1 is disclosed in co-pending U.S. patent application Ser. No. 09/201,737 (AMAT No. 2862), entitled “Apparatus for Storing and Moving a Cassette” and an exemplary automatic door opener is disclosed in U.S. Pat. No. 6,082,951. The '737 patent application and '951 patent are incorporated herein by reference in their entirety.

As shown in FIG. 1, loading and storage station 20 includes a frame 22 on which storage shelves 24 are mounted. In the exemplary loading and storage station 20 shown in FIG. 1, the shelves 24 are arranged in a right-hand column 26 and a left-hand column 28 (partially obscured). Also mounted on the frame 22 is a loading platform 30 from which substrate carriers may enter and exit the loading and storage station 20.

The frame 22 also supports a substrate carrier handler robot 32 that transports substrate carriers among storage shelves 24, loading platform 30 and the docking station 51. The robot 32 includes a linear guide structure 34. The linear guide structure 34 of the robot 32 includes a horizontal guide 36 and a vertical guide 38 which is mounted for movement in a horizontal direction on the horizontal guide 36.

FIG. 2 is an isometric view that shows a typical one of the storage shelves 24. The shelf 24 includes a horizontal surface 40 on which three locator pins 42 are installed. The locator pins 42 are positioned on the surface 40, and have a shape and size mandated in accordance with a standard promulgated by SEMI (Semiconductor Equipment and Materials International).

In accordance with the SEMI standard, the loading platform 30 and the docking stations 51 may have the same configuration of locator pins as the storage shelves 24.

An angle bracket 44 may be mounted at one side of the shelf 24. A beam emitter 46 may be mounted near the top of the angle bracket 44 and in a position above and offset to a side of the shelf 24. An L-shaped window 48 is provided to allow the beam (dashed line 50) from the beam emitter 46 to be received by a beam receiver (155, FIG. 14; not shown in FIG. 2) mounted on the lower side of the shelf 24. The beam emitter 46 and beam receiver together form a conventional “carrier present” sensor for generally detecting the presence or absence of a substrate carrier at the shelf 24.

FIG. 3 is a bottom plan view of a conventional substrate carrier 52 (e.g., a Front Opening Unified Pod (FOUP)). The bottom surface 54 of the substrate carrier 52 includes three guide grooves 56 that are positioned and configured in accordance with a SEMI standard to kinematically interact with the locator pins 42 shown in FIG. 2.

FIG. 4 is a side view showing a substrate carrier 52 positioned to be engaged by an end effector 58 of a type that may be included in the robot 32. The end effector 58, which is not visible in FIG. 1, may be mounted for vertical movement along the vertical guide 38 (FIG. 1). It will be recalled that the vertical guide 38 is mounted for horizontal movement on the horizontal guide 36. Consequently the end effector 58 may be moved vertically (along the Z axis 39 in FIG. 1) and horizontally (along the X axis 37 in FIG. 1). Continuing to refer to FIG. 4, the end effector 58 engages the substrate carrier 52 by an overhead transport (OHT) flange 60 mounted on the top of the substrate carrier 52. The OHT flange 60 is provided on the substrate carrier 52 in accordance with the above-mentioned SEMI standard. The configuration of the OHT flange 60 is also mandated by the SEMI standard. The end effector 58 shown in FIG. 4 may be of a type disclosed in U.S. patent application Ser. No. 09/894,322, (AMAT 5769) filed Jun. 27, 2001 and entitled “End Effector for Lifting Semiconductor Wafer Carrier”, commonly assigned with the present application. The patent application is incorporated herein by reference in its entirety.

FIG. 5 is an isometric view of the end effector 58 shown in FIG. 4. FIG. 6 is a side view of the end effector 58, and FIG. 7 is a sectional view of the end effector taken at line VII-VII of FIG. 6. Shown in FIGS. 5 and 7 are sensors 62, 64 which are provided on the end effector 58 to detect whether the flange 60 (FIG. 4) of a substrate carrier 52 is present at, and properly engaged by, the end effector 58.

Referring once again to FIG. 1, a controller 66 is associated with the storage and loading station 20 to control operation of the robot 32 and to receive signals output from the various sensors that have been referred to above.

As part of the installation of a storage and loading station such as the station 20 shown in FIG. 1, it is known to “calibrate” the robot 32. Calibration of the robot 32 includes storing in the controller 66 precise data indicative of horizontal and vertical positions at which the robot 32 is to hand off a substrate carrier to or from each shelf 24 or other position at which a substrate carrier may be placed in the storage and loading station 20 such as the loading platform 30 or the docking stations 51. According to conventional practice, during calibration the robot is driven by manual input signals so that the end effector 58 is moved, in turn, to each storage shelf 24, the loading platform 30 and the docking stations 51. At each of these locations, hand off points are determined by visual observation, and the corresponding locations of the end effector 58 are stored in the controller 66 for future reference during automatic substrate carrier transport operations. The process of manually controlling the robot 32 and visually determining the hand off points is a difficult and time consuming process that extends the period of time required for installation of the storage and loading station 20. It would be desirable to reduce the time and 30 effort involved in calibrating the substrate carrier handling robot used in storage and loading stations and other facilities in which substrate carriers are automatically transported.

### SUMMARY OF THE INVENTION

According to a first aspect of the invention a jig for use in a robot calibration process is provided. The jig includes a first part adapted to be engaged by an end effector of a substrate carrier handling robot and a second part attached to the first part and adapted to interact with a sensor associated with a substrate carrier storage location.

The jig may include a vertically extending body and a first vertical plate mounted at a lower end of the body and having at least one slit formed in the plate and adapted to allow a beam of a carrier-present sensor to pass through the slit. The jig may further include a horizontal flange mounted at a top of the body and adapted to emulate an overhead transport flange of a standard substrate carrier.

The at least one slit in the first vertical plate may include a pair of slits that are horizontally spaced from each other and are respectively adapted to allow a light beam from a carrier present sensor of a right hand storage shelf and a left hand storage shelf to pass therethrough.

The jig may further include a horizontal base plate mounted on a bottom of the vertically extending body and having a plurality of guide grooves formed in a lower surface of the base plate and adapted to interact with locator pins on a carrier storage location. The base plate may also have formed therein a pair of slits that correspond to the slits in the first vertical plate and are also adapted to allow a beam of a carrier-present sensor to pass therethrough.

The jig may further include a second vertical plate mounted on the body inwardly (i.e., closer to the vertically extending body) from the first vertical plate and having at least one slit formed in the second vertical plate and adapted to allow a beam of a carrier-present sensor of the docking station to pass through the slit in the second vertical plate.

The jig may further include columns that support the horizontal flange at the top of the vertically extending body and adapted so that the lower sensor of the end effector may shine between the columns.

According to a second aspect of the invention, a method of calibrating a substrate carrier handling robot is provided. The method includes providing a jig and detecting a position of the jig relative to a substrate carrier storage location and/or relative to the substrate carrier handling robot.

According to further aspects of the invention, a method of calibrating a substrate carrier handling robot may include juxtaposing a jig with a substrate carrier storage location and moving an end effector of the robot relative to the substrate carrier storage location. The method may further include allowing a sensor associated with one of the end effector and the substrate carrier storage location to interact with the jig, and detecting a location of the end effector at a time when the sensor interacts with the jig.

The term “substrate carrier storage location”, as used in this specification and the appended claims, includes any location at which a substrate carrier may be placed, including a storage shelf, a load/unload station, and a docking station. “Juxtaposing a jig with a substrate carrier storage location”, as used in this specification and the appended claims, includes placing the jig at or adjacent to the substrate carrier storage location.

The sensor allowed to interact with the jig may be a carrier-present sensor associated with a substrate carrier storage location, where the carrier-present sensor emits a beam that is allowed to pass through a slit formed in the jig.

Alternatively, the sensor allowed to interact with the jig may be mounted on the robot end effector and may be employed to detect a horizontal flange located at a top portion of the jig. As another alternative, the sensor mounted on the end effector may be employed to detect a column that supports the horizontal flange.

The sensor allowed to interact with the jig may be a sensor adapted to detect contact between a locator pin of the storage location and the jig, and the interaction may involve lifting the jig from the substrate carrier storage location to deactuate the sensor.

According to another aspect of the invention a method of calibrating a substrate carrier handling robot includes placing a jig on a substrate carrier storage location, and using a sensor mounted on an end effector of the robot to detect a location of a feature on the jig.

The methods of the present invention may utilize existing sensors associated with substrate carrier storage locations and with the carrier handling robot to interact with a novel jig that in some respects emulates a substrate carrier and in other respects provides features that aid in the calibration process. By manipulating the jig, and detecting sensor interactions with the jig, the substrate carrier handling robot is able to automatically calibrate itself, thereby avoiding the tedious and time consuming tasks involved in conventional manual calibration processes.

Further features and advantages of the present invention will become more fully apparent from the following detailed description of the preferred embodiments, the appended claims and the accompanying drawings.

### BRIEF DESCRIPTION OF THE DRAWINGS

FIG. 1 is an isometric view of a substrate carrier storage and loading station in which the present invention may be applied;

FIG. 2 is an isometric view of a storage shelf that is part of the storage and loading station of FIG. 1;

FIG. 3 is a bottom plan view of a conventional substrate carrier;

FIG. 4 is a side view of the substrate carrier of FIG. 3, positioned to be engaged by an end effector included in a substrate carrier handling robot that is part of the storage and loading station of FIG. 1;

FIG. 5 is an isometric view of the end effector shown in FIG. 4;

FIG. 6 is a side view of the end effector;

FIG. 7 is a vertical sectional view of the end effector showing sensors mounted thereon;

FIG. 8 is a side schematic representation of a jig that may be used for calibrating a substrate carrier handling robot in accordance with the invention;

FIG. 9 is a top isometric view of an exemplary embodiment of a jig provided in accordance with the invention for use in an inventive calibration procedure for a substrate carrier handling robot;

FIG. 10 is a side view of the jig of FIG. 9;

FIG. 11 is a bottom plan view of a base plate of the jig of FIGS. 9 and 10, shown in isolation;

FIG. 12 is a flow chart that summarizes a robot self-calibration procedure carried out in accordance with the invention;

FIG. 13 is a more detailed flow chart that illustrates a self-calibration procedure carried out in accordance with the invention by a substrate carrier handling robot;

FIG. 14 is a schematic side view showing the jig of FIG. 9 interacting with a carrier-present sensor at a substrate carrier storage location; and

FIG. 15 is a schematic side view showing the jig of FIG. 9 positioned on locator pins at a substrate carrier storage location.

### DETAILED DESCRIPTION OF PREFERRED EMBODIMENTS

In accordance with the invention a substrate carrier handling robot calibrates itself, using a novel jig that partly emulates a standard substrate carrier. The jig also includes features that may be detected by sensors provided at substrate carrier storage locations and/or by sensors mounted on the end effector of the substrate carrier handling robot. By suitable automatic movements of the jig by the robot, and detection of interactions between the jig and the sensors on the substrate carrier storage locations and on the robot end effector, the robot controller is able to determine handoff points for the substrate carrier storage locations rapidly and precisely through automatic operation of the substrate carrier handling robot, and without human intervention.

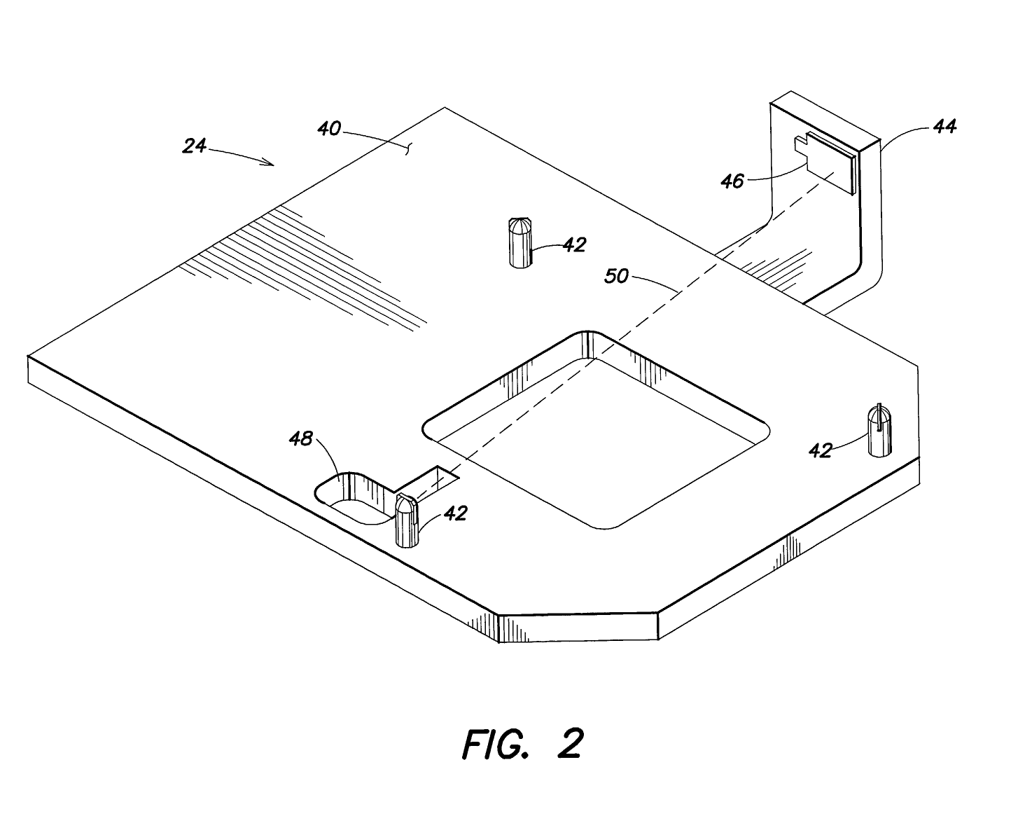

Each locator pin 42 of the storage shelves 24 (FIG. 2) may be integrated with a sensor for detecting placement of a substrate carrier on the shelf 24. The integration of the sensors with the locator pins may be provided in accordance with teachings of U.S. patent application Ser. No. 09/894,383 (AMAT No. 5770) filed Jun. 27, 2001 entitled “Locator Pin Integrated with Sensor for Detecting Semiconductor Substrate Carrier” and commonly assigned with the present application. This co-pending application is incorporated herein by reference in its entirety. In general, however, the integrated locator pin/sensor includes a pin-shaped body that has a slot formed therein. A paddle is accommodated in the slot. The paddle is downwardly actuated when a substrate carrier is seated on the locator pin/sensor. Downward actuation of the paddle actuates a sensor included in the locator pin/sensor and therefore indicates the presence of a substrate carrier.

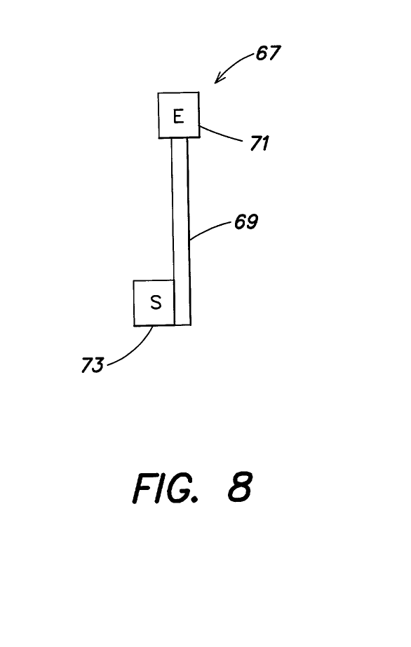

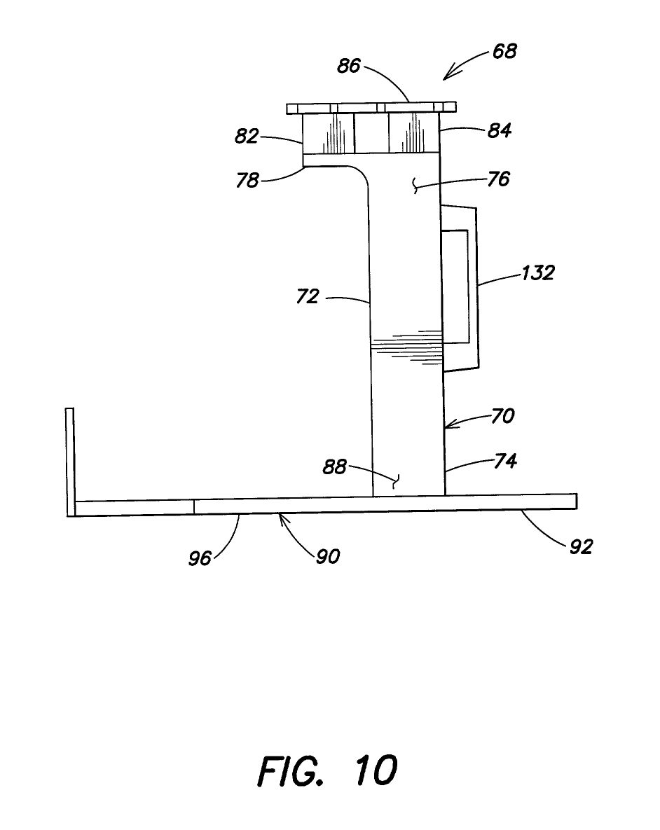

Initially the jig employed for the self-calibration process will be described with reference to FIGS. 8-11.

FIG. 8 is a schematic representation of a jig 67 that may be employed for a self-calibration process in accordance with the invention. Jig 67 includes a body 69 to which an engagement part 71 is attached. The engagement part 71 is adapted to be engaged by an end effector (e.g., end effector 58, FIG. 5) of a substrate carrier handling robot that is to be self-calibrated. Engagement part 71 is shown attached to an upper end of body 69 but instead may be located anywhere that it is convenient to do so or as required for engagement by the end effector of the substrate carrier handling robot to be self-calibrated.

Jig 67 further includes a sensor-interaction part 73 attached to the body 69. The sensor-interaction part 73 is adapted to interact with a sensor such as a carrier-present sensor associated with a substrate carrier storage location or a sensor associated with a locator pin of a substrate carrier storage location. Sensor-interaction part 73 is shown attached to a lower end of body 69 but instead may be located anywhere that it is convenient to do so or as required for interaction with a sensor.

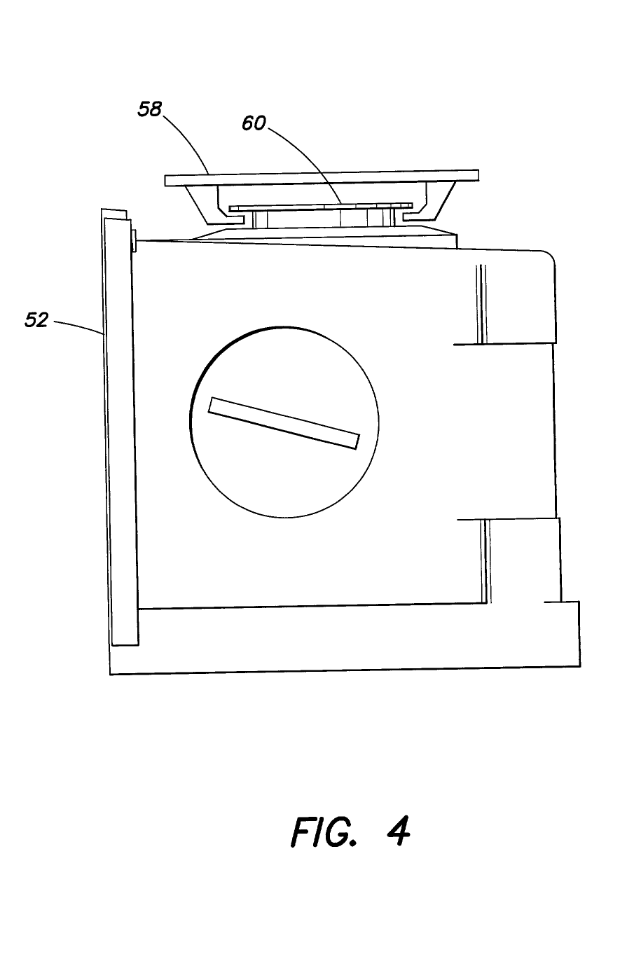

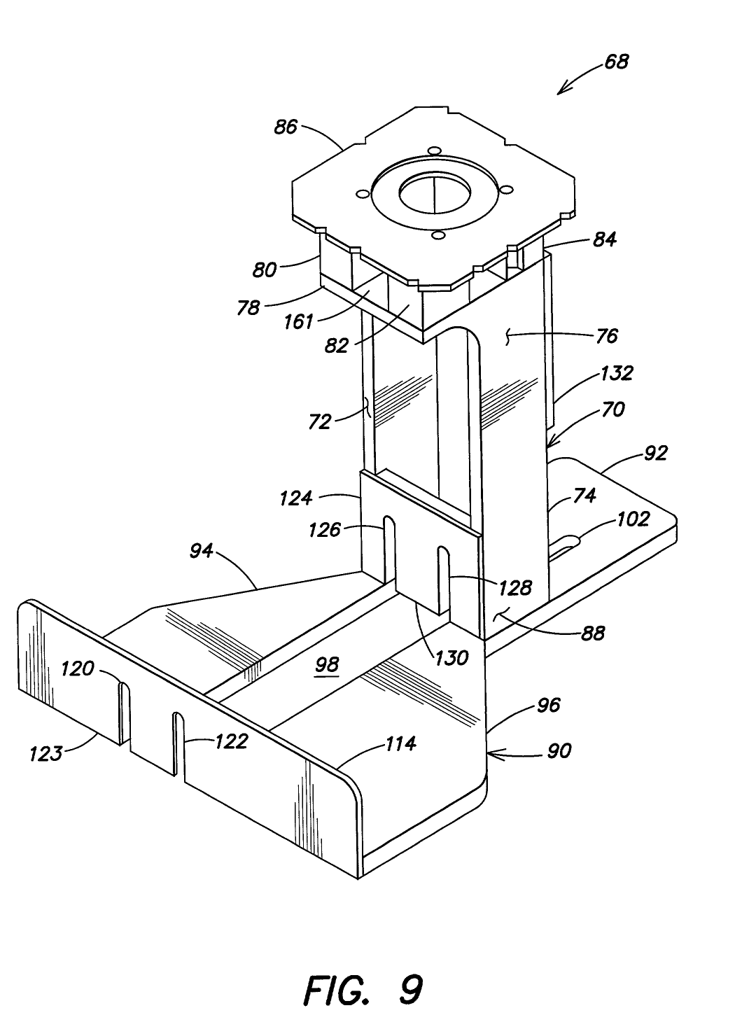

FIGS. 9-11 illustrate an exemplary embodiment of a jig provided in accordance with the invention for use in a self-calibration process. In FIGS. 9-11, reference numeral 68 generally indicates an exemplary embodiment of the inventive jig. The jig 68 includes a generally rectangular, vertically-extending body 70. The body 70 has a front side 72 and a rear side 74 that is opposite to the front side 72. At an upper end 76 the body 70 curvedly flares outwardly in a forward direction to form a pedestal 78 that has a wider horizontal cross section than the main portion of the body 70. Rising vertically upwardly from the pedestal 78 are four columns, of which columns 80, 82 and 84 are visible in the drawings. Mounted on the columns 80, 82, 84 and the fourth (unseen) column is a horizontal flange 86. The flange 86 has the same size, shape and configuration as the OHT flange 60 (FIG. 4) of the standard substrate carrier used with the facility for which the robot calibration is to be performed. In other words, the horizontal flange 86 of the jig 68 corresponds to the above-mentioned SEMI standard and thus emulates the OHT flange of the standard substrate carrier.

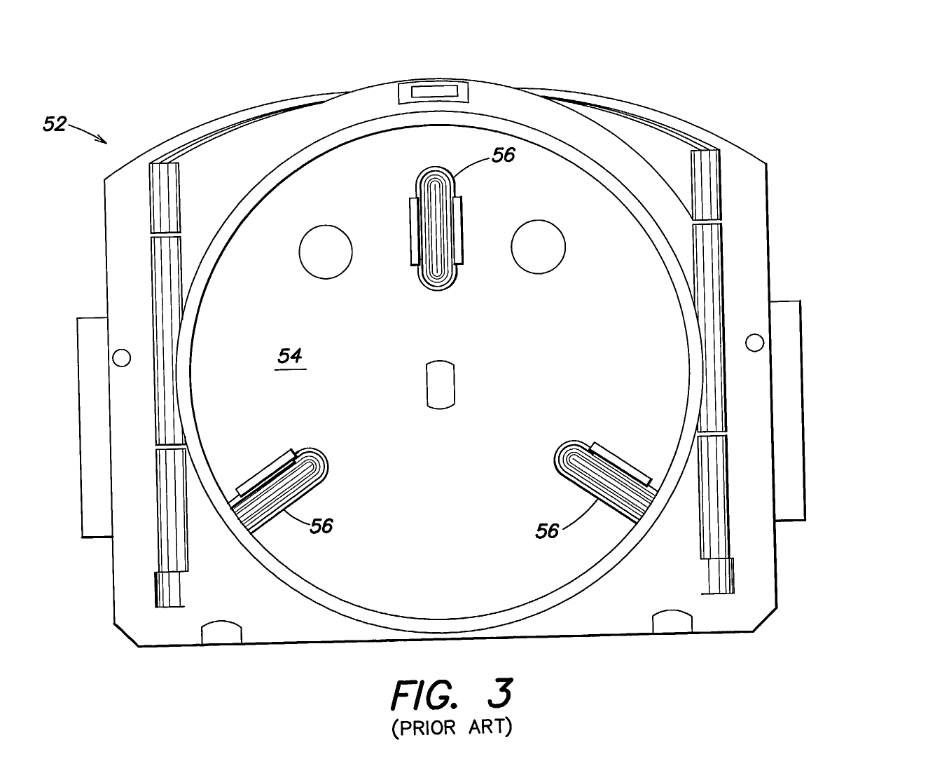

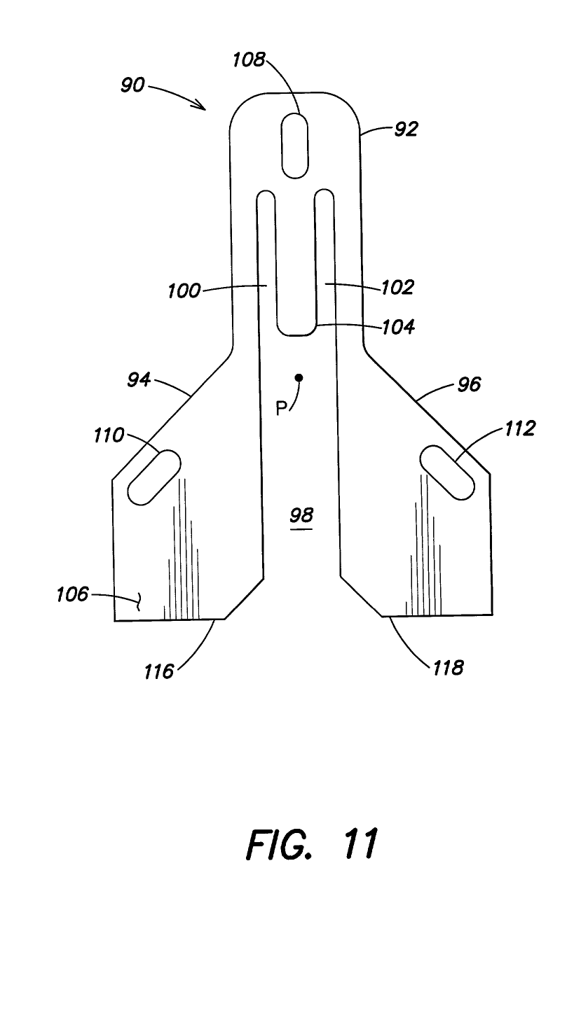

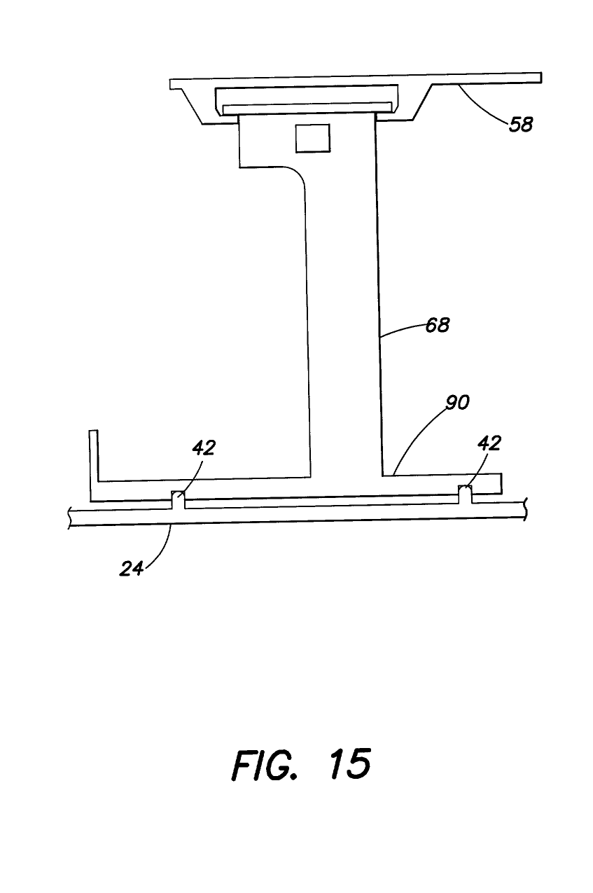

A lower end 88 of the body 70 has mounted thereto a base plate 90. The configuration of the base plate 90 is best seen from FIG. 11 which is a bottom plan view thereof. As seen from FIG. 11, the base plate 90 includes a root portion 92 at a rearward end thereof. Wings 94 and 96 extend forwardly and outwardly from the root portion 92. The wings 94, 96 define a slot 98 therebetween. Extending rearwardly from the slot 98 are parallel slits 100 and 102. A tongue 104 is defined between the slits 100, 102. A bottom surface 106 of the base plate 90 has guide grooves 108, 110 and 112 formed therein. Specifically the guide groove 108 is formed at the root portion 92, guide groove 110 is formed at the wing 94, and guide groove 112 is formed at the wing 96. The guide grooves 108, 110, 112 correspond in size, shape, configuration and location to the guide grooves 56 (FIG. 3) formed in the bottom of the standard substrate carrier used in the facility for which the calibration procedure is to be performed. In other words, the guide grooves 108, 110, 112 correspond to the above-mentioned SEMI standard and thus are adapted to interact with the locator pins 42 (FIGS. 2 and 15) provided on the shelves 24 and the other substrate carrier storage locations.

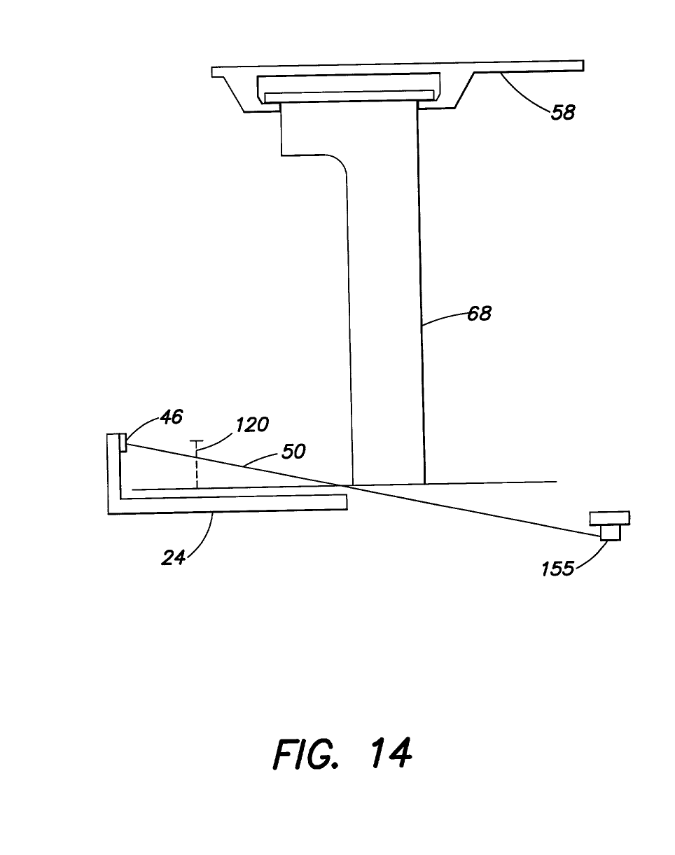

Referring again to FIG. 9, a first vertical plate 114 is mounted on, and extends upwardly from respective forward edges 116, 118 (FIG. 11) of wings 94, 96. Vertical slits 120, 122 are formed in the first vertical plate 114. The slits 120, 122 extend upwardly from a lower edge 123 of first vertical plate 114 and are parallel to and spaced apart from each other. The positions of the slits 120, 122 in the lateral direction of the base plate 90 correspond to the lateral edges of slot 98. Further, the lateral position of slit 120 corresponds to the lateral position of slit 100 (FIG. 11) in base plate 90, whereas the lateral position of slit 122 corresponds to the lateral position of slit 102 in base plate 90. Thus slit 120, slot 98 and slit 100 form a path of travel for a light beam 50 (FIGS. 2 and 14) of a carrier-present sensor of a shelf 24. Similarly, slit 122, slot 98 and slit 102 form another path of travel for a light beam 50 of a carrier-present sensor of a shelf 24.

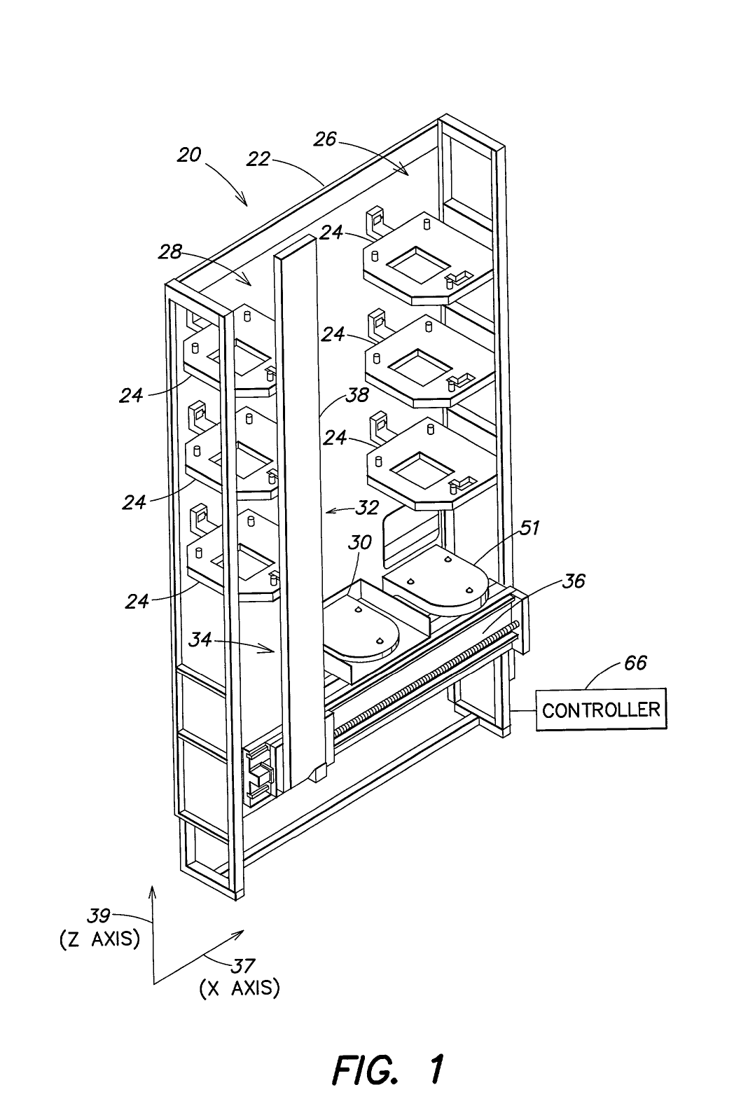

As will be seen, either one of the slits 120, 122 may be used to determine the location of the jig relative to a storage shelf 24 by detecting when a beam 50 of a cassette-present sensor installed on the shelf 24 passes through the slit 120 or 122. Two slits 120, 122 are provided in the first vertical plate 114 to accommodate the two different placements of the cassette-present sensor relative to the shelf 24, depending on whether the shelf 24 is a right-hand shelf (i.e., in right-hand column 26, FIG. 1) or a left-hand shelf (i.e., in left-hand column 28). This is also the reason for the positions of 126, 128, 100, 102 (for right-hand and left-hand docking stations) and the width of 98 (for right and left-hand docking stations and shelves). Although two slits 120, 122 are provided in the first vertical plate 114 in the preferred embodiment of jig 68 shown in FIG. 9, only one slit may be provided in first vertical plate 114 or an opening large enough to encompass both slits 120 and 122 may be employed.

Continuing to refer to FIG. 9, a second vertical plate 124 is mounted on a lower portion of front side 72 of body 70 of jig 68. As seen from FIG. 9, second vertical plate 124 is mounted inwardly (closer to body 70) relative to first vertical plate 114. Second vertical plate 124 has slits 126, 128 formed therein. The slits 126, 128 extend upwardly from a lower edge 130 of the second vertical plate 124. Slits 126, 128 are spaced from each other and parallel to each other. Slits 126 and 128 have respective lateral positions that correspond to the lateral positions, respectively, of slits 120, 122 (and thus also correspond to the lateral positions of slits 100, 102).

It will be observed from FIG. 9 that second vertical plate 124 has a height that is greater than the height of first vertical plate 114. Moreover, the slits 126, 128 are longer (longitudinally) than the slits 120, 122. Second vertical plate 124, with its slits 126, 128, is provided to selectively pass the beam of a carrier-present sensor that is associated with a docking station 51 (FIG. 1). As will be understood by those who are skilled in the art, the carrier-present sensor associated with conventional docking stations emits a beam at a higher angle than the beam 50 of the carrier-present sensor associated with the storage shelves 24. The greater height of second vertical plate 124 (relative to first vertical plate 114) and the longer length of slits 126, 128 (relative to slits 120, 122) accommodate the higher angle of the docking station's carrier-present sensor beam relative to the sensor beam of the carrier-present sensor of the storage shelves 24. Note in this example, only one of the slits 126, 128 is used for calibration with respect to the docking station. The right slit is used for the docking station on the right and the left slit is used for the docking station on the left.

A handle 132 is mounted on the rear side 74 of body 70 of jig 68. The handle 132 may extend vertically along the rear side 74 of the body 70 and provides a convenient feature for permitting a human operator to grasp the jig 68.

Because jig 68 has flange 86 and base plate 90, which respectively emulate the OHT flange and bottom surface of a standard substrate carrier, the jig 68 emulates the handling and placement characteristics of a standard substrate carrier.

### Self-Calibration Procedure

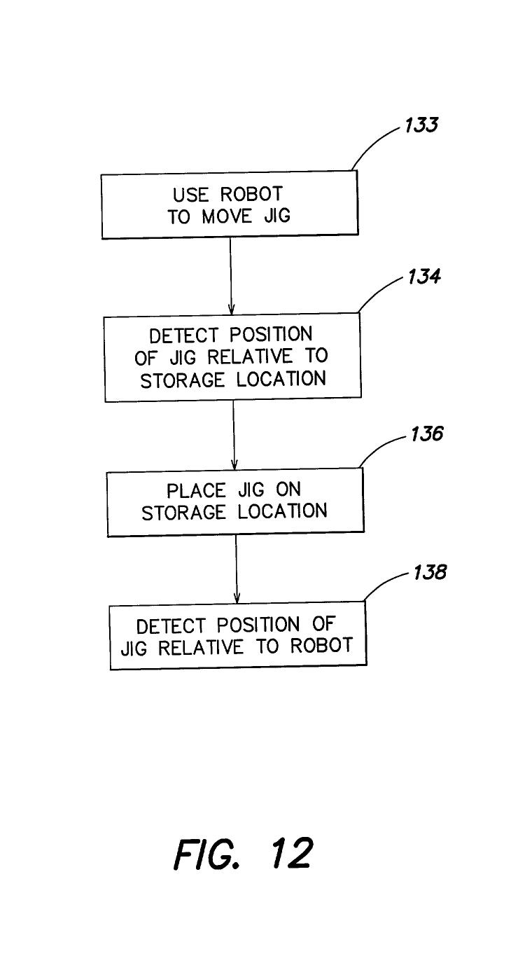

An automatic self-calibration procedure carried out in accordance with the invention will now be summarized with reference to FIG. 12.

The self calibration procedure involves using the substrate carrier handling robot 32 to move the jig 68, as indicated by step 133 in FIG. 12. The position of the jig 68 relative to a storage location is detected (step 134), and the jig 68 is placed by the robot 32 on the substrate carrier storage location (step 136). Then the position of the jig 68 relative to the robot 32 is detected (step 138). Data gathered during these operations is stored as self-calibration data.

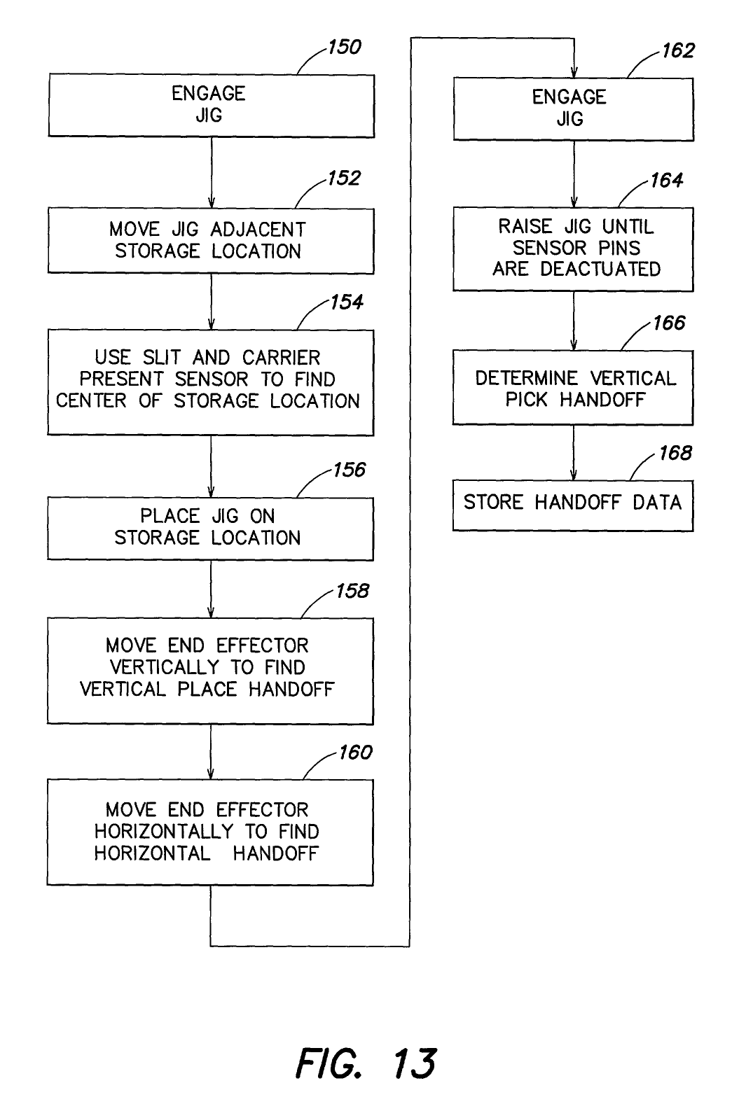

A more detailed description of the self-calibration process will now be provided with reference to FIG. 13. The automatic calibration procedure may comprise computer program code and/or a computer program product that may be stored in the controller 66, or stored in a computer readable medium.

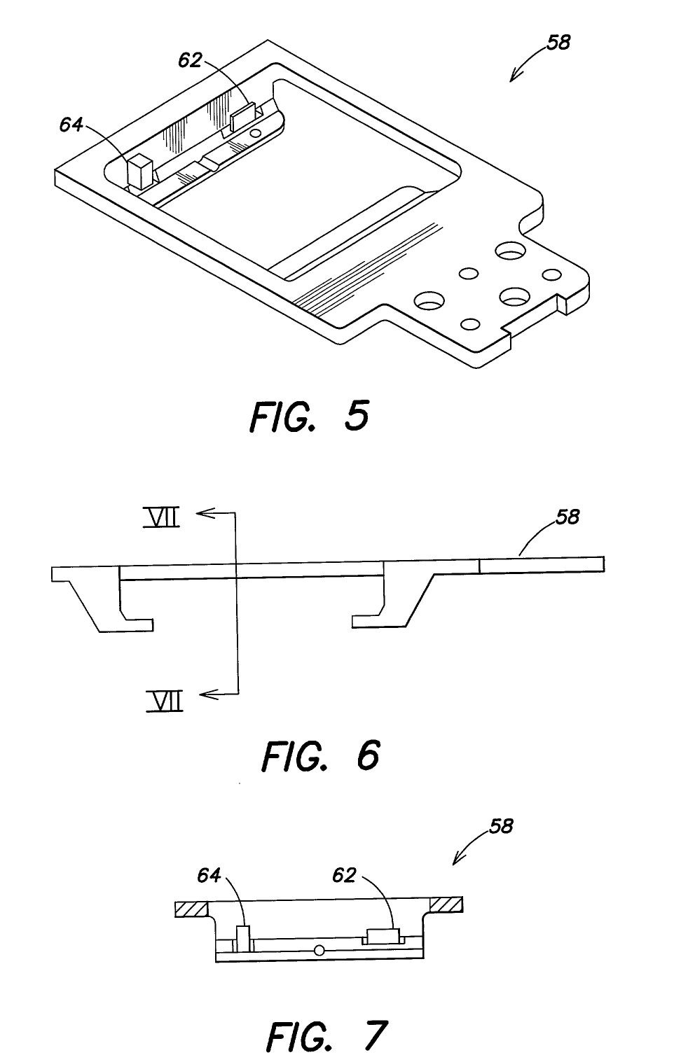

Initially, at step 150 in FIG. 13, a human operator places the jig 68 so that it is engaged by the end effector 58 (FIG. 6) of robot 32 (FIG. 1). More specifically, the jig 68 is placed so that the end effector 58 engages the horizontal flange 86 (FIG. 9) of the jig 68. The operator may then provide input to the controller 66 (FIG. 1) to initiate an automatic calibration operation and to select a substrate carrier storage location, such as one of the storage shelves 24, as to which the automatic calibration operation is to be performed. The controller 66 may have previously been programmed to recognize the approximate location of each of the substrate carrier storage locations. The purpose of the automatic calibration operation is to determine precise hand-off points for the selected substrate carrier storage location.

Before commencing to move the jig 68 that is engaged by the end effector 58, the controller 66 may first check a number of interlock conditions to confirm that it is appropriate to proceed with the automatic calibration operation. For example, it may be confirmed that the jig has been engaged by the end effector 58. This condition may be detected via the sensors 62, 64 provided on the end effector 58 (FIG. 7). Further, it may be confirmed that the carrier-present sensor (FIG. 2) of the selected substrate carrier storage location is not indicating the presence of a substrate carrier or other object at the substrate carrier storage location. Furthermore, it may be confirmed that the sensors integrated with the locator pins 42 for the selected substrate carrier storage location do not indicate placement of a substrate carrier or other object on the locator pins 42.

If the substrate carrier storage location selected for calibration is a docking station, it may be confirmed via appropriate sensors that the station is not docked (i.e., that a moveable substrate carrier platform is not in the wafer extraction position, which differs from the substrate carrier receipt position) and is not latched in place on the substrate carrier platform.

A similar checking of interlock conditions may be performed prior to each subsequent stage of the automatic calibration operation to confirm that it is safe to proceed with the automatic calibration operation.

Assuming that the checking of the interlock conditions has produced appropriate results, the process of FIG. 13 proceeds from step 150 to step 152. At step 152 the robot 32, under automatic control by controller 66, uses the end effector 58 to move the jig 68 adjacent to the substrate carrier storage location that has been selected for calibration. The jig 68 is held in the end effector 58 so that the first vertical plate 114 faces the beam emitter 46 (FIG. 2) of the carrier-present sensor installed on the selected substrate carrier storage location (or if a docking station is selected rather than a storage location, the jig 68 is held in the end effector 58 so that the second vertical plate 124 faces the beam emitter of the carrier-present sensor installed on the docking station).

Next, at step 154 in FIG. 13, as the jig 68 is moved adjacent to the substrate carrier storage location one of the slits 120, 122, 126 or 128 (FIG. 9) interacts with the beam 50 (FIG. 2) of the carrier-present sensor to determine the center of the selected substrate carrier storage location. Step 154 is schematically illustrated in FIG. 14, which is a side view showing end effector 58 of robot 32 (FIG. 1) transporting jig 68 above storage shelf 24. Beam 50 emitted by beam emitter 46 of the carrier-present sensor associated with shelf 24 passes through slit 120 of jig 68 and is received by beam receiver 155 of the carrier-present sensor. Step 154 may include a procedure in which a dark-to-light transition is detected with respect to one edge of the slit, and then a second dark-to-light transition is detected via the carrier present sensor to determine the location of the other edge of the slit (e.g., the end effector 58 carries the jig 68 horizontally so that the beam 50 impacts the respective edges of the slit 120). By storing the locations of the end effector 58 at the times when the edges of the slit are detected, the controller 66 is able to calculate an appropriate center location for the selected substrate carrier storage location. Note that the shelf's center is calculated (e.g., by adding an appropriate offset) because pin 42 is located at the shelf's center, therefore window 48 must be offset from the shelf's center.

The controller 66 is then able to control the robot 32 to place the jig 68 on the locator pins 42 (FIG. 2) of the selected substrate carrier storage location (step 156, FIG. 13). Step 156 is illustrated by FIG. 15, which is a somewhat schematic side view of jig 68 being placed on locator pins 42 of shelf 24 by end effector 58. The locator pins 42 kinematically cooperate with the guide grooves 108, 110, 112 of the base plate 90 of the jig 68 to guide the jig 68 to an appropriate placement position on the selected carrier storage location, just as if the jig 68 were a substrate carrier being placed on the selected substrate carrier storage location.

Once the carrier-placement sensors associated with the locator pins 42 indicate proper placement of the jig 68 on the substrate carrier storage location, the end effector 58 disengages from the jig 68 (e.g., moving slightly vertically so that it is no longer contacting the jig's OHT flange 86) and moves vertically to cause the sensor 64 on the end effector 58 to interact with the top flange 86 of the jig 68 to determine the vertical hand-off position for placement of a substrate carrier (“vertical place position”) at the selected substrate carrier storage location (step 158, FIG. 13). That is, the end effector 58 is moved downwardly so that one of the sensors thereon provides a light-to-dark transition indicative of the top edge of the flange 86. After the end effector 58 is moved downwardly an appropriate distance (sufficient to pass the lower edge of the flange 86), it is then moved upwardly to detect via one of the sensors, a light-to-dark transition indicative of the lower edge of the flange 86. From the detected locations of the upper and lower edges of the flange 86, a center position in the vertical direction of the flange 86 may be calculated. To this position an appropriate downward offset may be added to indicate a vertical hand-off at which the end effector 58 would clear the bottom of the flange 86 (or the OHT flange of a substrate carrier), so that for placement operations the end effector 58 then can be moved horizontally away from the jig or substrate carrier.

Next, with the jig 68 remaining in place on the locator pins 42 of the selected substrate carrier storage location, and the end effector 58 disengaged from but proximate to the flange 86 of the jig 68, the controller 66 moves the end effector 58 horizontally to determine a precise horizontal hand-off position relative to the substrate carrier storage location (step 160, FIG. 13). More specifically, the sensor 64 on the end effector 58 (FIG. 5) is used, in conjunction with horizontal movement of the end effector 58, to detect the horizontal boundaries of a space 161 (FIG. 9) formed between columns 80 and 82 at the top of the jig 68. Consequently, edges of columns 80 and/or 82 are also detected.

For example, the end effector 58 may be moved horizontally so that the sensor 64 detects one light-to-dark transition indicative of one edge of the column 82 and/or 161. Then the end effector 58 is moved horizontally in the opposite direction to detect a second light-to-dark transition indicative of the opposite edge of the column 82 and/or 161. Information indicative of the locations of these edges is stored, and then based on one or more previously-stored off-sets, a horizontal pick and place position is calculated for the substrate carrier storage location in question. That is, because the horizontal distance between the edges of the space 161 and a point P central to the guide grooves 56 (FIG. 11), is known, this distance can be used to calculate the horizontal pick and place location. When the end effector 58 is positioned in the horizontal pick and place position a substrate carrier supported by the end effector 58 is positioned such that its guide grooves 56 will be properly seated on the shelf 24's locator pins 42.

Next the end effector 58 is moved to the calculated horizontal pick and place location and is then raised so as to re-engage the jig 68 (step 162, FIG. 13). The end effector 58 continues to raise so as to disengage the guide grooves 108, 110, 112 (FIG. 11) of the jig 68 from the locator pins 42 (e.g., FIG. 2) of the substrate carrier storage location. The controller 66 detects a vertical location at which the sensors associated with the pins 42 are all deactuated (step 164, FIG. 13). The controller 66 notes the vertical location at which deactuation of the sensor pins is detected, and then, on the basis of a previously-stored upward off-set, calculates a vertical pick hand-off position (step 166) at which the end effector 58 would be raised sufficiently for the bottom of a substrate carrier to clear the locator pins 42.

The horizontal pick and place hand-off position determined at step 160, the vertical place hand-off position determined at step 158 and the vertical pick hand-off position determined at step 166 are then stored (step 168) so that calibration of the robot 32 with respect to the selected substrate carrier storage location is complete. It will be appreciated that the end effector 58, with the jig 68 engaged therein, may then be moved to the determined vertical pick hand-off location, and subsequently returned to the location at which the jig was originally inserted into the end effector 58 by the human operator. The jig may then be taken by the human operator from the end effector 58, or another substrate carrier storage location may be selected for calibration.

Except for the human operator placing the jig in the end effector (step 150) and selecting a substrate carrier storage location for calibration, all of the procedures described in connection with FIG. 13 are carried out automatically by the robot and controller, without human intervention. The elapsed time required to perform the self calibration procedure for one substrate carrier storage location may be on the order of a few minutes.

By using the jig disclosed herein and the above-described procedure, a substrate carrier handling robot and its associated controller operate to self-calibrate to determine optimal hand-off positions for substrate carrier storage locations of a storage and/or loading station of a substrate processing facility. Consequently, the time-consuming and labor-intensive manual calibration procedure employed in accordance with the prior art can be avoided. Thus installation of the storage and/or loading station is performed more easily and more quickly than in the prior art.

The foregoing description discloses only the preferred embodiments of the invention, and modifications of the above disclosed apparatus and methods which fall within the scope of the invention will be readily apparent to those of ordinary skill in the art. For example, instead of using the end effector sensor or sensors to detect the location of the columns of the jig 68 and/or the space between the columns, the location of one of the columns may be detected. Naturally, the number of and shape of the columns may vary, so long as an opening exists for detecting a light/dark transition. Furthermore, the precise configuration of the jig may be varied, so long as it has such features as a top flange and a bottom surface that emulate a standard substrate carrier, one or more slits to interact with cassette-present sensors of the substrate carrier storage locations, and a suitable feature to be used for detecting a horizontal position of the jig when placed on locator pins of a substrate carrier storage location.

Accordingly, while the present invention has been disclosed in connection with the preferred embodiments thereof it should be understood that other embodiments may fall within the spirit and scope of the invention as defined by the following claims.

The invention claimed is:

1. A jig for use in a robot calibration process, comprising:
a first part adapted to be engaged by an end effector of a substrate carrier handling robot; and
a second part attached to the first part and adapted to interact with a sensor associated with a substrate carrier storage location.

2. The jig of claim 1, wherein the first part includes a horizontal flange.

3. The jig of claim 1, wherein the second part includes a plate having a slit formed therein and adapted to allow a beam of a carrier-present sensor to pass through the slit.

4. The jig of claim 1, wherein the second part includes a base plate adapted to actuate a sensor associated with a locator pin on the substrate carrier storage location.

5. A jig for use in a robot calibration process, comprising:
a vertically extending body;
a first plate mounted at a lower end of the body and having at least one slit formed in the plate and adapted to allow a beam of a carrier-present sensor to pass through the slit; and
a horizontal flange mounted at a top of the body and adapted to emulate an overhead transport flange of a standard substrate carrier.

6. The jig of claim 5, wherein the at least one slit in the first plate includes a pair of horizontally spaced slits that are respectively adapted to allow a light beam from a carrier present sensor of a right hand storage shelf and a left hand storage shelf to pass therethrough.

7. The jig of claim 6, further comprising a horizontal base plate mounted on a bottom of the body and having formed therein a pair of slits that correspond to the slits in the first plate and are respectively adapted to allow a light beam from a carrier present sensor of a right hand storage shelf and a left hand storage shelf to pass therethrough.

8. The jig of claim 7, wherein the base plate has a plurality of guide grooves formed in a lower surface thereof and adapted to interact with locator pins on a substrate carrier storage location.

9. The jig of claim 5, further comprising a horizontal base plate mounted on a bottom of the body and having a plurality of guide grooves formed in a lower surface of the base plate, the guide grooves being adapted to interact with locator pins on a substrate carrier storage location.

10. The jig of claim 9, further comprising a pair of columns joining the flange to the body and having a known horizontal position relative to the plurality of guide grooves.

11. The jig of claim 5, further comprising a second plate mounted on the body and having at least one slit formed therein and adapted to allow a beam of a docking station's carrier-present sensor to pass through the slit in the second plate.

12. The jig of claim 11, wherein the second vertical plate is mounted inwardly of the first vertical plate.

13. The jig of claim 5, further comprising a handle mounted on a side of the body and extending vertically along the side of the body.

14. The jig of claim 13, wherein the handle is mounted on an opposite side of the body relative to the first plate.

15. A jig for use in a robot calibration process, comprising:
a vertically extending body;
a base plate mounted on a bottom of the body and extending horizontally away from the body and having three guide grooves formed in a bottom surface of the base plate, the guide grooves emulating guide grooves formed in the bottom of a substrate carrier to interact with locator pins on a carrier storage location;
a first vertical plate extending upwardly from a front edge of the base plate, the first vertical plate having a pair of slits formed therein, the slits extending in parallel in a vertical direction and spaced from each other, the slits adapted to allow beams from carrier-present sensors to pass through the slits;
a second vertical plate mounted at a lower end of the body and inwardly from and parallel to the first vertical plate, the second vertical plate having a pair of vertically-extending slits formed therein in respective positions corresponding to the slits of the first vertical plate;
a set of at least two columns extending upwardly from an upper end of the body; and
a horizontal flange mounted on the set of columns, the flange adapted to emulate an overhead transport flange of a standard substrate carrier.

16. A method, comprising:
providing a jig; and
detecting a position of the jig relative to a substrate carrier storage location.

17. The method of claim 16, wherein the detecting step is performed while moving the jig with an end effector of a substrate carrier handling robot.

18. The method of claim 16, wherein the position of the jig is detected using a sensor installed in association with the substrate carrier storage location.

19. A method, comprising:
providing a jig; and
detecting a position of the jig relative to a substrate carrier handling robot.

20. The method of claim 19, wherein the detecting step is performed while the jig is positioned on a substrate carrier storage location.

21. The method of claim 19, wherein the position of the jig is detected using a sensor carried by an end effector of the substrate carrier handling robot.

22. A method of calibrating a substrate carrier handling robot, comprising the steps of:
juxtaposing a jig with a substrate carrier storage location;
moving an end effector of the robot relative to the substrate carrier storage location;
allowing a sensor associated with one of the end effector and the substrate carrier storage location to interact with the jig; and
detecting a location of the end effector at a time when the sensor interacts with the jig.

23. The method of claim 22, wherein the allowing step includes allowing a beam emitted by a sensor associated with the substrate carrier storage location to pass through a slit formed in the jig, while the jig is engaged by the end effector.

24. The method of claim 22, wherein the allowing step includes using a sensor mounted on the end effector to detect a horizontal flange located at a top portion of the jig.

25. The method of claim 22, wherein the allowing step includes using a sensor mounted on the end effector to detect a column that supports a horizontal flange located at a top portion of the jig.

26. The method of claim 22, wherein the allowing step includes lifting the jig from the substrate carrier storage location to deactuate at least one sensor pin provided at the substrate carrier storage location.

27. A method of calibrating a substrate carrier handling robot, comprising the steps of:
emitting a sensor beam via a sensor installed at a substrate carrier storage location;
moving a jig relative to a substrate carrier storage location via the substrate handling robot;
detecting when a sensor beam passes through a slit formed in the jig; and
determining a position of the substrate handling robot relative to the substrate carrier storage location, based on a position of the substrate handling robot when the sensor beam passes through the slit formed in the jig.

28. The method of claim 27, wherein the moving step includes engaging and moving the jig by means of an end effector of the robot, and further comprising detecting a location of the end effector at the time when the beam passes through the slit.

29. A method of calibrating a substrate carrier handing robot, comprising the steps of:
placing a jig on a substrate carrier storage location; and
using a sensor mounted on an end effector of the robot to detect a location of a feature on the jig.

30. The method of claim 29, wherein the feature on the jig is a horizontal flange at a top of the jig, having a dimension of an overhead transport flange.

31. The method of claim 29, wherein the feature on the jig is a column that supports a horizontal flange at a top of the jig.

32. A method of calibrating a substrate carrier handling robot, comprising the steps of:
placing a jig on a substrate carrier storage location to actuate at least one sensor pin provided at the storage location;
raising the jig from the storage location; and
during the raising step, detecting a location at which the jig ceases to actuate the at least one sensor pin.

33. The method of claim 32, wherein the at least one sensor pin includes three sensor pins.

34. The method of claim 32, further comprising:
storing data indicative of the detected location; and
adding an offset to the stored data to produce data indicative of an elevation required to clear the sensor pins.

35. The method of claim 32, wherein the raising of the jig includes engaging and lifting the jig by means of an end effector of the robot.

36. A method of calibrating a substrate carrier handling robot, comprising the steps of:
(a) engaging a jig with an end effector of the robot;
(b) moving the jig relative to a substrate carrier storage location;
(c) allowing a sensor beam to pass through a slit formed in the jig, wherein the sensor beam is emitted by a sensor installed at the substrate carrier storage location;
(d) detecting a location of the end effector at a time when the beam passes through the slit;
(e) calculating an initial horizontal placement position based on a result of the detecting step;
(f) placing the jig on the substrate carrier storage location at the initial horizontal placement position so that the jig engages locator pins provided on the substrate carrier storage location;
(g) moving the end effector vertically to detect a location of a top flange of the placed jig by means of a first sensor mounted on the end effector;
(h) determining a vertical place position on the basis of the detected location of the top flange of the jig;
(i) moving the end effector horizontally to detect a location of at least one column of the jig by means of a second sensor mounted on the end effector;
(j) determining a final horizontal placement position based on a result of step (i);
(k) engaging the placed jig by the end effector and lifting the jig from the locator pins to deactuate sensors that detect the jig's contact with the top of the locator pins;
(l) detecting a location of the end effector when the deactuated sensors detect the jig's lack of contact with the top of the locator pins;
(m) determining a vertical pick position based on a result of step (l); and
(n) storing the determined vertical place position, the final horizontal placement position and the vertical pick position.

37. The method of claim 36 wherein lifting the jig from the locator pins to deactuate sensors comprises deactuating a sensor integrated with a locator pin.

38. The jig of claim 15 further comprising a handle mounted on a rear side of the body and extending vertically along the rear side of the body, the rear side of the body facing away from the first and second vertical plates.
